(19) United States
(12) Patent Application Publication
(10) Pub. No.: US 2010/0209580 A1
(43) Pub. Date: Aug. 19, 2010

(54) PRODUCT SHAPING METHOD AND APPARATUS

(76) Inventors: Emine Unlu, Murfreesboro, TN (US); Francis S. Shields, Nashville, TN (US); Allan Torney, Brampton (CA); William Gharibian, Smyrna, TN (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/691,831

(22) Filed: Jan. 22, 2010

Related U.S. Application Data
(60) Provisional application No. 61/146,713, filed on Jan. 23, 2009.

(51) Int. Cl. A23P 1/12; B29C 47/22; B29C 47/06; B29C 47/92; B29C 47/08; A47J 36/00

(52) U.S. Cl. 426/516; 425/466; 425/133.1; 425/143; 425/292; 426/512; 99/357

(57) ABSTRACT

This invention provides apparatus and methods for producing cooked material having a desired shape that varies in cross-sectional dimension.

### CROSS REFERENCE TO RELATED APPLICATIONS

This application claims the benefit of U.S. Patent Application Ser. No. 61/146,713, filed Jan. 23, 2009, the disclosure of which is hereby incorporated by reference as if set forth in its entirety.

### TECHNOLOGY FIELD

This invention relates to food products and to processes for their preparation and use, as well as apparatus for preparing said food products. This invention generally relates to the shaping of products for consumption. More particularly, this invention relates to apparatus and methods for varying the cross-sectional shape of a product. The products can be intended either for human or for animal consumption.

### BACKGROUND

Current continuous pumping and shaping systems in the prior art are classified into two categories: those that impart variable cross-sectional shape into the pumped material and those that do not. Systems that do continuously change the shape of the extrudate typically pump a material with low viscosity, or control the viscosity to maintain a low pressure range tolerable for the shaping device. The art teaches, for example, dough pumping systems such as those manufactured by Bepex Hutt of Germany or encrusting machines such as those manufactured by Rheon of Japan that pump materials of minimal inherent viscosity with the ability to vary the cross sectional shape of the product. Many of these dough type materials undergo subsequent processing such as baking to form the final shape of the product and functionally change the dough into a cooked material. Similarly, melt process extrusion systems control the processing temperature of the plastic extrudate to control viscosity in a low range. Extrudate viscosity is a key factor in the ability to change the opening shape of the die orifice.

Conversely, cooker extruder systems and other cooked material pumps have not demonstrated the ability to continuously shape the cross section of the product during discharge from the shaping die orifice(s) because of the high pressure encountered. This problem exists as a result of the rate of extrusion, the high viscosity of the pumped material resulting from functional and chemical changes in the extrudate, and the resulting high pressures encountered from a combination of both. Extruder valves have been demonstrated in the prior art for the purposes of diverting the extrudate to an alternate discharge or to restrict the flow of the extrudate prior to the cooker extruder shaping die to impart energy and control density of expanded (see, for example, U.S. Pat. No. 6,773,739).

However, the art does not provide methods or apparatus that can produce a product having a specified final shape having a variable cross-sectional area, because shaped products must undergo further processing (such as cooking) that can result in shape changes in the materials. This increases the need for manual manipulation to ensure a desired final product shape, which is inefficient compared with more fully-automated regimes. These deficiencies are exacerbated as the desired shape of the final product is more complex.

Thus, there remains a need in the art for automated control of the shape of a food product to provide products having a variable cross sectional machined shape that is retained in the final food product, as well as a need for automated control of production to efficiently yield complex shapes in conjunction with food processing and pumping systems.

Current food production technologies have relatively low production rates when creating products with significantly varying cross-section. It would be advantageous to have a high production rate, low waste process for making products with variable cross-sections. Additionally, it would be advantageous if these products required only minimal processing after being shaped to be ready for consumption. The art teaches a variety of apparatus and methods for producing uncooked food products, or food products that are not otherwise functionally changed, having a substantially spheroid shape, where the product comprises a paste or jelly interior surrounded by a dough covering. In the production of these food products, it has been advantageous to use extruder means, particularly low pressure screw or roller extruders, to form a rope-like or columnar material that is treated by a valve head to convert the continuous rope into discrete substantially spheroid products. These products are then subjected to further processing, including, inter alia, cooking. Examples of this technology are set forth, for example, in U.S. Pat. Nos. 4,251,201; 4,743,024; 4,767,304; 4,767,305; 5,098,273; 5,153,010; 5,190,770; 5,967,025; 6,174,154; 6,248,385; 6,443,055; 6,709,256; 7,021,604; 7,153,119.

The current art has the disadvantage that changes or modifications of food product shape are not effected using completely automated processes and apparatus. These existing methods—such as rotary forming or stamping—often require human intervention or additional processing to produce a final product shape, and these processes are inefficient because they produce waste and are inherently discontinuous. Also, the required secondary processing, which can include cooking or other functional changes, can have a deleterious effect on product shape. Automating such shape changes has been difficult, in part because of conditions arising during processing, such as substantially increased pressures encountered at higher production rates and with cooked or otherwise functionally-changed products. Existing machines are not equipped to handle these conditions.

Thus, there remains a need in the art for automated control of the shape of a food product to provide products having a machined shape that is retained in the final food product, as well as a need for automated control of production to efficiently yield complex shapes.

### SUMMARY

The present invention provides a variable opening die apparatus comprising the die, and methods for continuously producing a consumable food product having a varying cross-sectional shape or cross-sectional area or both.

In a first aspect, the invention provides a variable opening die for forming a shaped body comprising a supporting member, an aperture having a shape and an area, a plurality of shaping or cutter members, and a plurality of attachments for attaching the plurality of shaping or cutter members to the supporting member, wherein the plurality of shaping or cutter members define the shape and the area of the aperture; and the plurality of attachments are adapted to allow the plurality of shaping or cutter members to move to change the shape and the area of the aperture.

In a second aspect, the invention provides apparatus for forming a shaped body comprising: one or a plurality of supply element for continuously supplying one or more materials as a single product stream; and a variable opening die of the first aspect of the invention, wherein the single product stream is provided to the variable opening die; and at least one supply element is capable of supplying a functionally changed material to the single product stream.

In a third aspect, the invention provides apparatus for forming a shaped body comprising, a first extruder for continuously supplying a first material; a second extruder for continuously supplying a second material, a co-extrusion head having a first inlet, a second inlet, and an outlet, wherein the co-extrusion head is adapted to produce a single product stream comprising the first material surrounded by the second material, wherein the first extruder is in communication with the first inlet an the second extruder is in communication with the second inlet; and a variable opening die of the first aspect of the invention, wherein at least one extruder is capable of producing a functionally changed material; and the aperture of the variable opening die is in communication with the outlet of the co-extrusion head.

In a fourth aspect, the invention provides methods for making a shaped food product comprising, providing a single product stream to the aperture of a variable opening die of the invention; and varying the aperture area or shape or both while the single product stream passes through the aperture to form a shaped product having a predetermined cross-sectional area and a predetermined cross-sectional shape, wherein at least one of the cross-sectional area and cross-sectional shape of the shaped product is varied during production of the shaped food product.

In a fifth aspect, the invention provides methods for producing a plurality of final formed food products using an apparatus according to the invention, wherein the plurality of final formed food products differ by having a final formed shape or recipe or both shape and recipe, wherein the different shapes of the two formed food products are produced by different aperture shape, area, or both shape and area of the variable opening die used to produce each of the two final formed food products, or the recipe of each of the two final formed food products is different and the two final formed food products are produced sequentially in the apparatus.

Apparatus of the invention can advantageously yield high product production rates and low excess wastage, while permitting the cross-section of a single product to be varied during production. The high production rate can be achieved by cooking or functionally changing at least a portion of the product during the extrusion phase, and forming the product as it exits the variable opening die. Flow of the product is controlled by restricting the opening of the variable die in order to attain a desired product shape. The majority of the functional changes to the product take place in the extruder, although some additional functional changing can take place after the product exits the extruder, resulting from pressure and temperature generated as the product is provided to the die. Final product attributes, such as product temperature and/or water content, can be further modified after the product exits the die, however, the cross-sectional shape and the cross-sectional area of the product is determined as the product exits the variable opening die.

Specific embodiments of the present invention will become evident from the following more detailed description of certain preferred embodiments and the claims.

### BRIEF DESCRIPTION OF THE DRAWINGS

FIG. 1a illustrates a top view of an embodiment of the open variable opening die.

FIG. 1b illustrates a top view of an embodiment of the closed variable opening die.

FIG. 2 illustrates a side view of a variable opening die.

FIGS. 3a and 3b illustrate exemplary shaped products.

FIG. 4 depicts a specific embodiment of the product shaping apparatus of the invention.

FIG. 5 depicts an alternative embodiment of the product shaping apparatus of the invention.

FIG. 6 is a flow diagram of an exemplary method.

### DETAILED DESCRIPTION

As set forth in more detail below, the invention provides a variable opening die for continuously shaping an at least partially functionally changed or cooked food product, wherein the die provides a predetermined cross-sectional shape and a predetermined cross-sectional area to the food product by continuously changing its aperture shape and/or size while the food product passes through the die, such that at least one of the attributes of shape or area is varied.

Variable opening dies of the invention generally have a supporting member, such as an outer ring structure, and a plurality of cutting or shaping members arranged and anchored to the outer ring so that the extents of the cutting or shaping members are arranged to form an aperture having a variable shape or area and capable of receiving a single product stream, for example an at least partially cooked or otherwise functionally changed material, and forming at least a section of the product stream into a shaped product body having a variable cross-sectional area and/or variable cross-sectional shape.

As used herein, the terms “functionally change” or “functionally changed” are intended to encompass cooking foodstuffs as well as any process that irreversibly changes the physical or chemical properties of a material, for example, a foodstuff Functional changes, include, but are not limited to, cooking. Particular embodiments of methods for effecting a functional change on a material (e.g., a foodstuff) includes treating the material at temperatures, pressures or both temperatures and pressures above ambient temperature and pressure. Alternative methods include but are not limited to changing the chemical composition of the foodstuff by contacting the foodstuff with an acid, a base, various types of sugars, fats and oils, organic and/or inorganic salts thereof, catalysts, emulsifiers, dough conditioners, humectants, and palatability enhancers.

When a product stream is continuously motivated through the variable opening die it can be continuously shaped by a continuously changing shape and area of the aperture, resulting in a shaped product whose cross-sectional shape and/or cross-sectional area has been defined by the shape and area of the aperture as the product stream passes through the aperture.

As used herein, the term “cross-sectional shape” means the geometrical shape formed by the perimeter of a cross-section of a product taken normal to the direction that the product passes through the die of the invention (i.e., normal to the flow direction). As used herein, the term “cross-sectional area” means the area of the geometrical shape formed by the perimeter of a cross-section of a product taken normal to the direction that the product passes through the die of the invention (i.e., normal to the flow direction).

The shape and area of the aperture of the variable opening die are defined by the plurality of shaping or cutting members. By adjusting the positioning of the shaping or cutting members, either by rotation, sliding, and/or vertical or horizontal translation, the shape and/or size (i.e., area defined by the shape) of the aperture can be altered, and advantageously may be continuously altered.

Alternatively, the variable opening die of the invention can comprise a plurality of shaped, generally curved, members arranged in sliding contact with one another wherein movement of the members around, for example, a common pivot point results in an aperture having a variable area. In further alternative embodiments, the variable opening die can comprise a plurality of pins that can be differentially or in concert changed with regard to the area or shape of an aperture formed by a plurality of one extent of the pins.

In one embodiment, all of the members can be controlled in concert so as to uniformly open and close the variable opening die. This serves to deliver a shaped product having a uniform cross-sectional shape, but a variable cross-sectional area. In another embodiment, each of the members can be controlled individually. Such control allows for a shaped product to have a variable cross-sectional shape and a variable cross-sectional area. In each of the preceding scenarios, multiple members are arranged around each single point of contact along the sides of the product stream as it passes through the variable opening die.

The variable opening die of the invention can comprise a controller for controlling the changing of the area and/or shape of the aperture of the die as discussed above. In certain embodiments, the variable opening die can be controlled by a programmed, repeating, or continuous function. In certain embodiments, said function is automated, for reliably and efficiently producing at least partially cooked or otherwise functionally changed material having a predetermined shape. Said controller can be manually operated but more advantageously is automated, inter alia, under the control of a computer or other device programmed to change the area and/or shape of the variable opening die to provide the desired cross-sectional area, shape or both to the product.

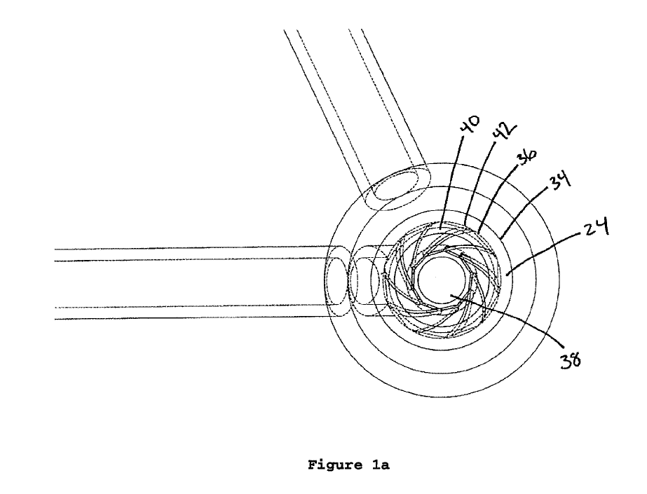

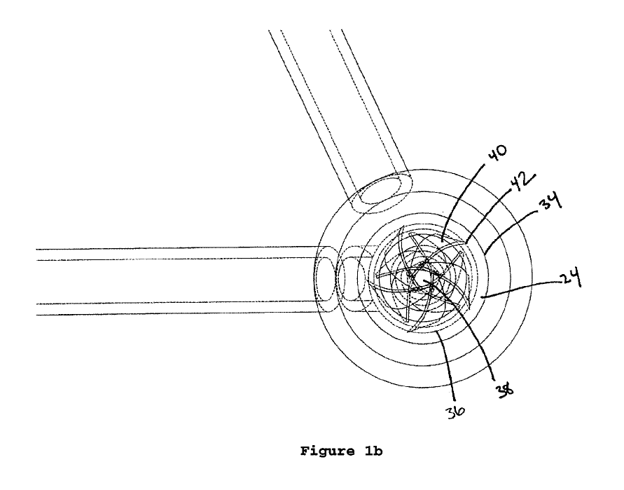

One type of variable opening die of the invention is illustrated in top view in FIG. 1a; therein is shown open variable opening die 24. Variable opening die 24 comprises an outer circumference 34, an inner circumference 36, an aperture 38, a plurality of cutter members 40, and a plurality of attachments 42. Outer circumference 34 and inner circumference 36 form an outer ring 44. Outer ring 44 can comprise a rigid material, such as a metal or a plastic. Cutter members can also be made of a rigid material such as metal or hard plastic. Each of the plurality of cutter members 40 is attached to outer ring 44 with an attachment 42. Each of the attachments 42 acts as a pivot for one of the plurality of cutter members 40.

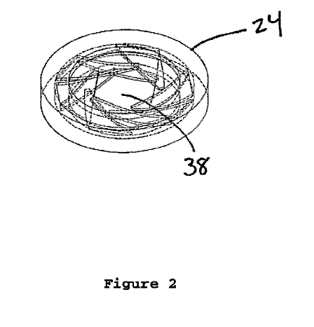

As shown in FIG. 1a, each of the plurality of cutter members 40 can rotate about one of the attachments 42 to collectively form aperture 38, through which combined material 30 flows to form shaped product 32. The size and shape of aperture 38 can be altered by the rotation of the plurality of cutter members 40 about their respective attachments 42. If the plurality of cutter members 40 were originally disposed to create the widest possible aperture 38, some rotation of each the plurality of cutter members 40 in the same direction would create the medium-sized aperture shown in FIG. 1a. Continued rotation of the plurality of cutter members 40 in the same direction decreases the size of aperture 38 until aperture 38 is substantially closed, as shown in FIG. 1b. FIG. 2 illustrates a perspective view of an exemplary embodiment of variable opening die 24. The perspective view of variable opening die 24 could correspond to the embodiment of variable opening die 24 shown in FIGS. 1a and 1b.

The preceding variable opening die can be utilized in cooperation with one or more supply elements in an apparatus of the invention, where the supply elements provide a single product stream, from one or a plurality of materials, to the aperture of the variable opening die for forming a shaped product body having a variable cross-sectional dimension. Generally, at least one material comprising the single product stream is a functionally changed material. For example, one of the materials can be functionally changed as a result of processing within a supply element. The supply elements can be directly coupled to the variable opening die of the invention or can be coupled via one or more transition tubes from the supply element to the variable opening die or to one or more inlets of a co-extrusion head coupled to the variable opening die.

A transition tube can be situated in the flow path between the one or more supply elements and the variable opening die. When there are two or more supply elements, the transition tube can be situated between the co-extrusion head and the variable opening die or between each of the supply elements and the co-extrusion head. Decreasing the cross-sectional area of the product stream prior to passing through the variable opening die can control the pressure drop at the die and optimize the flow profile. In certain embodiments, the internal cross-sectional area of the transition tube decreases from the end that accepts the single product stream to the end in communication with the variable opening die or the co-extrusion head. Transition tubes can have a length of about 0.25-10 feet, and in certain embodiments, about 1-7 feet or about 0.5-3 feet.

The cross-sectional shape of the product stream is modified by changing either the area or the shape of the aperture or both as the product stream passes through the variable opening die. The resulting shaped product has a predetermined cross-sectional shape and a predetermined cross-sectional area where at least one of the shape and area is variable. Generally, the shaped product is continuously formed in the shape of a continuous material (e.g., a rope or bar) which can be cut into a plurality of pieces according to methods known to those skilled in the art. The repeating nature of the function which can control the present die means that separating one product from the next simply requires the continuous material to be cut at predetermined intervals, avoiding the waste of unusable material between products. In certain embodiments, the variable opening die of the invention comprises a cutting element positioned to accept the shaped product body from the aperture and adapted to cut the shaped product body into pieces at pre-defined positions and/or predefined intervals. Further, the variable opening die allows for the continuous shaping of the single product stream whether the stream comprises one or a plurality of components.

As used herein, the term “co-extrusion head” means a structure capable of accepting one or a plurality of materials and produces a single product stream comprising the one or the plurality of materials. For example, a co-extrusion head can provide a single product stream comprising (1) a first material surrounded by a second material; or (2) a plurality of laminated layers (e.g., a stack of layers), as well as other alternatives appreciated by those skilled in the art. The co-extrusion head can also comprise a die plate or nozzle to provide a cross-sectional shape to one or more of the materials.

As used herein, the term “transition tube” means a tube which can accept a product stream from a first apparatus element and provide the stream to a second element. In certain embodiments, the transition tube decreases the cross-sectional area of the product stream. The cross-sectional area of the product stream can be altered, for example, in one or a plurality of discontinuous changes at one or more positions along the length of the tube (e.g., a telescoping and decreasing cross-sectional area); can be altered continuously at a plurality of positions along the length of the transition tube; or any combination thereof.

In an embodiment, the transition tube can comprise multiple members that can be controlled in concert or individually along multiple points of contact along the length of the transition tube leading up to the final forming point at the variable opening die where the members allow for changing the cross-sectional area and/or cross-sectional shape of the product stream prior to the final forming point.

In one example, the members comprise pins arranged in a plurality of sets along the length of the transition tube such that the interior cross-sectional area of the transition tube can be essentially defined by the end faces of the various pins (i.e., the transition tube comprises a stack of sets of pins). The end faces of the pins can be concave, convex, or essentially planar.

Alternatively, the transition tube may comprise a series of variable opening valves to control the changes or maintenance of the diameter of the product as it passes through the valves.

Each supply element independently motivates the one or more materials as a single product stream through the variable opening die, and can comprise, for example, an extruder, a pump, and/or a piston. Preferably, the supply elements are extruders. The processing performed by extruders can include mixing, kneading, compressing, sugar solubilization, starch gelatinization, protein denaturation, fat melting and emulsification, cross-linking (between proteins, starches, or fats), crystallization, viscosity modification, freezing, cooling, browning, cooking, or imparting energy into the material inside the extruder.

The processing performed by the extruders can functionally change the material ingredients inside the extruder. For example, such a functional change within one or more extruders can be controlled and effected by changing the temperature inside the extruder, for example, increasing the temperature inside the extruder, or by increased pressures experienced by a material, for example, slipping over flights of the screws comprising the extruder, and pressure can affect cooking or functional changes inside the extruder. The addition of liquid to the material while the material is inside an extruder can transform the material that enters as substantially dry, ground matter into a material having the consistency of dough, viscose mass, or pliable extrudate. Each material can be pre-conditioned, for example, to hydrate and/or incorporate ingredients (e.g., fats and other ingredients) in a continuous steam inclusion mixer, before being sent through one of the supply element and into the apparatus.

The temperature of the cooked or otherwise functionally-changed food product can be controlled directly or indirectly, inter alia by liquid injection (for example, using steam or water), electrical heating bands, or jacketed barrels of circulating heating or cooling fluid. Other operating parameters, such as pressure in the apparatus, can be controlled; for example, apparatus of the invention can be adapted to pressures of up to 3000 psi, for example, in a range from 100 to 3000 psi; more typically being in a range of 100 and 2000 psi, or 100 to 1000 psi, or 500 to 2000 psi, or 1000 to 2000 psi. Said pressures can be generated by application of external pressure or as the result of the force with which the cooked or otherwise functionally-changed food product is motivated in the apparatus and the shape or area of the variable opening die. The skilled worker will appreciate that the apparatus is advantageously adapted for a range of internal pressures, and changes therein as the result of changing the shape or area of the variable opening die.

Further, the apparatus can be adapted to maintain or change the temperature of the cooked or otherwise functionally-changed food product using heating or cooling elements or channels integral to or in thermal contact with the apparatus. In addition, in any of these embodiments the apparatus is adapted to maintain or change the pressure on the cooked or otherwise functionally-changed food product. In these embodiments, the variable opening die is adapted to the increased pressures, consistencies and/or temperatures necessary for providing a functionally-changed food product. In certain embodiments, the functional change is cooking. As such, in other embodiments, the apparatus of the invention further comprises a temperature controller for changing the temperature of the functionally changed material in the apparatus.

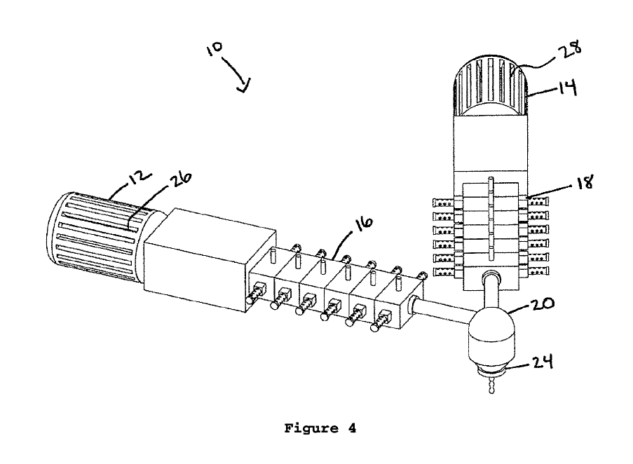

In certain embodiments, the variable opening die 24 can be positioned so that aperture 38 is substantially parallel to the ground (vertically disposed; see, FIG. 2), as would be the case in the exemplary embodiment of the product shaping apparatus shown in FIG. 4 (infra), gravity supplements the motivation of a combined material 30, provided by pressure differential between inside and outside of the system as a result of the functional change in the product as well as shaping of the product, through aperture 38 to create shaped product 32. Products falling vertically from the variable opening die can advantageously fall onto a horizontally moving belt and then taken away from the product shaping apparatus. The speed of the closing and opening of variable opening die 24 is dictated by the extrusion rate of combined material 30 and the size of the individual pieces of shaped product and shape details 32.

An alternative embodiment of variable opening die 24 is horizontally disposed. This embodiment is not shown in the Figures but may be achieved by merely rotating co-extrusion head 20 and variable opening die 24 so that material exits from each in the horizontal direction. As gravity can deform a product being horizontally disposed through the variable opening die, this embodiment can be used advantageously but not exclusively for smaller products with low weight or density. Alternatively, a product substantially bar- or stick-shaped cannot suffer deformation from being horizontally disposed. The horizontally disposed products can be vacuumed from the end of the variable opening die.

In other embodiments, the apparatus can be adapted to facilitate movement of the one or more materials within the apparatus by an internal coating comprising a material having a low coefficient of friction or a lubricant.

A particular embodiment of a product shaping apparatus of the invention is shown in FIG. 4. Product shaping apparatus 10 comprises a first material reservoir 12 and a second material reservoir 14, a first extruder 16 and a second extruder 18, a co-extrusion head 20, and a variable opening die 24. First material reservoir 12 contains an outer material 26. The first material reservoir 12 and second material reservoir 14 may be, but are not limited to, surge hoppers that meter material into extruders. Second material reservoir contains a filling material 28. First extruder 16 and second extruder 18 are both physically connected to co-extrusion head 20. First extruder 16 and second extruder 18 may be, but are not limited to, single screw and twin screw extruders. Multi-extrusion or co-extrusion head 20 is physically attached to variable opening die 24.

The operation of apparatus 10 creates a product from starting materials. Outer material 26 is contained in first material reservoir 12, exits first material reservoir 12 and flows through first extruder 16. First extruder 16 processes outer material 26 while outer material 26 flows through first extruder 16. Filling material 28 is contained in second material reservoir 14, exits second material reservoir 14 and flows through second extruder 18. Second extruder 18 processes filling material 28 while filling material 28 flows through second extruder 18.

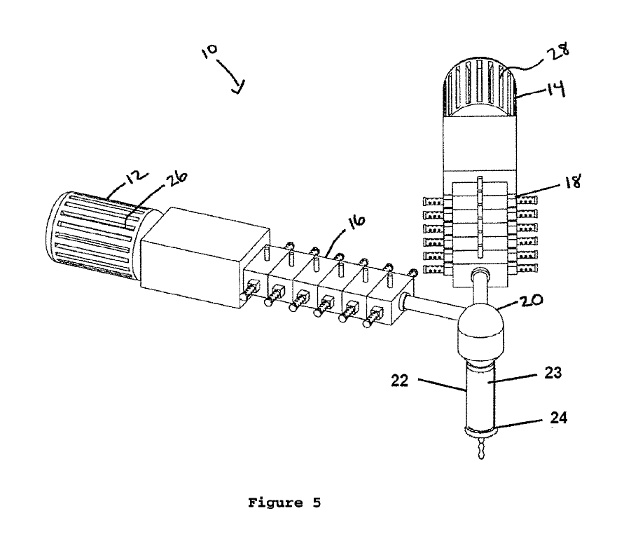

Another embodiment of product shaping apparatus is shown in FIG. 5. Product shaping apparatus 10 comprises a first material reservoir 12 and a second material reservoir 14, a first extruder 16 and a second extruder 18, a co-extrusion head 20, a transition tube 22, and a variable opening die 24. Transition tube 22 comprises an inside wall 23. First material reservoir 12 contains an outer material 26. Second material reservoir contains a filling material 28. First extruder 16 and second extruder 18 are both physically connected to co-extrusion head 20. Co-extrusion head 20 is physically attached to transition tube 22.

Outer material 26 and filling material 28 exit first extruder 16 and second extruder 18, respectively, and flow into co-extrusion head 20, wherein co-extrusion head 20 can manipulate the materials so that outer material 26 envelops filling material 28, creating combined material 30. Combined material 30 passes from the co-extrusion head 20 through transition tube 22 to variable opening die 24. The inside wall 23 of the transition tube may be tapered such that the diameter of the combined material 30 decreases as the combined material 30 progress through the transition tube 22 to reach the variable opening die 24.

Outer material 26 and filling material 28 can be thoroughly mixed prior to flowing through the extruders. Material reservoirs 12 and 14 can comprise pre-conditioners where some or all liquids, such as oil, water, glycerin, starch hydrolysates, stabilizers, meat slurries, color solutions, flavor solutions, or steam that are needed to create the material, can be added to starting liquid ingredients, semi-solid ingredients or dry ingredients such as powders. Materials can exit from the pre-conditioner having a liquid slurry consistency. Alternatively, the ingredients required to create outer material 26 and filling material 28 can be added directly to first extruder 16 and second extruder 18, respectively, in which those ingredients are continuously mixed for homogeneity.

The filling material can pass through a shaped die in the co-extrusion head so that the cross-section of the filling material would have a particular shape before being surrounded by the outer material. Alternatively, the co-extrusion head can cut through the outer material to shape the filling material—or the outer and filling materials can be pumped into the co-extrusion head at different rates—so as to give the filling material a particular shape. Cooking can take place as the material flows through co-extrusion head 20. This cooking can result from a progressive reduction in the cross-sectional area of co-extrusion head 20; an increased pressure experienced by the material flowing through co-extrusion head 20; melt flow through the length of co-extrusion head 20; and friction between the walls of co-extrusion head 20 and the material flowing through it. These methods of cooking can be used simultaneously in advantageous combinations. The temperature of co-extrusion head 20 can be controlled to affect these properties, and that control can be achieved by a jacketing or porting apparatus similar to those described above in relation to the extruders. Additionally, the controlled temperature could in turn control the expansion or contraction of the material as it moves through the apparatus. In a preferred embodiment, the product can remain flowable as it exits co-extrusion head 20 while reaching the desired level of cooking or functional modification. As the material is cooked, it is functionally changed; for example, protein within the material can undergo irreversible denaturation, starches go through gelatinization, crystalline ingredients melt. Extent of these transitions depends on the type, source and form of ingredients, product formulation, type of process as well as process conditions and settings.

The temperature of combined material 30 at the exit of the co-extrusion head 20 can fall within the range of about 0 to 300° C. The temperature of combined material 30 at the exit of co-extrusion head 20 preferably falls within the range of about 40-150° C. Pressures at co-extrusion head 20 are typically in the range of about 200 to 2000 psi, more preferably about 300 to 1800 psi, and most preferably about 400 to 1500 psi, although pressure values outside of this range are also contemplated.

In certain embodiments, combined material 30 flows through transition tube 22 after exiting co-extrusion head 20. A good seal is desirable between co-extrusion head 20 and transition tube 22 to prevent leakage of combined material 30, as the pressure experienced by the combined material 30 can be elevated (i.e., higher than ambient atmospheric pressure). In certain embodiments, an O-ring made for example from Teflon® can be used as a seal. Because transition tube 22 can create back pressure on combined material 30, low friction walls are desirable within transition tube 22 to reduce the effect of laminar flow. The inside wall of transition tube 22 can be uncoated, or it can be coated with a friction-reducing material such as Teflon® to reduce back pressure and promote slippage along the wall. Alternatively, oil or another lubricant can be applied to inside wall of transition tube 22 to coat the surface of the inside wall. Transition tube 22 can be designed so that its inner diameter is no less than the inner diameter of co-extrusion head 20 to keep the pressure experienced by combined material 30 from increasing while combined material 30 passes from co-extrusion head 20 to transition tube 22. Different nozzles can be placed at the exit of transition tube 22 which can have a smaller inner diameter, thus increasing the pressure as combined material 30 approaches the exit of transition tube 22.

Exemplary embodiments can be capable of processing about 1000 kg/hr of shaped product 32. Depending on the shape and size of the individual pieces of shaped product 32, this can translate into about 600-700 pieces of shaped product 32 per minute for a product size of 20 grams each. If each piece of shaped product weighs approximately 5 grams each, as many as 2000 pieces of shaped product 32 can be produced. To facilitate this level of throughput, the co-extrusion die/head can be made of a material capable of handling high pressures, such as metal (e.g., stainless steel), instead of materials like Teflon®.

Combined material 30 exits transition tube 22 and enters variable opening die 24. Variable opening die 24 shapes combined material 30 to form shaped product 32. Shaped product 32 can be a food product, for example for animals. Alternatively, shaped product 32 can be a food product for human consumption. Shaping is controlled by varying the area of the aperture of the variable opening die, wherein said variation can be continuous or discrete depending on the desired shape of the product.

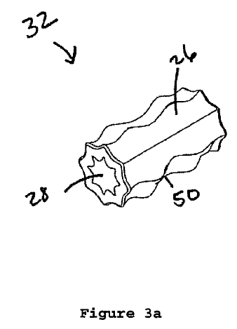

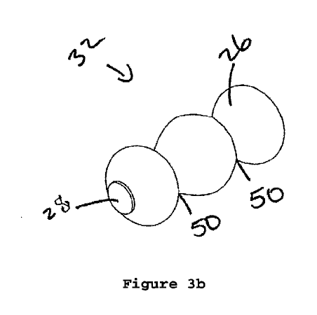

Exemplary shaped products are shown in FIGS. 3a and 3b. As has been described above, the exemplary shaped products produced by the apparatus and methods of the invention can comprise an inner filling material continuously surrounded along the shaping (e.g., extrusion) direction by an outer material.

The exemplary shaped product 32 shown in FIG. 3a has a eight-pointed star-shaped cross-section. Filling material 28 has a cross-sectional shape of a eight-pointed star, and outer material 26 surrounds filling material 28 such that the overall cross-sectional shape is also a eight-pointed star. At indentations 50, the cross-sectional area of example shaped product 32 has local minima, such that at each indentation 50 the cross-sectional area is less than the cross-sectional area at the immediately surrounding areas of example shaped product 32. Variable opening die 24 is programmed, for example, with a continuous, repeating function that would create smooth variations in cross-sectional shape and multiple indentations 50 as depicted in FIG. 3a.

The exemplary shaped product 32 shown in FIG. 3b has a circular cross-section. Filling material 28 has a cross-sectional shape of a circle, and outer material 26 surrounds filling material 28 such that the overall cross-sectional shape is also a circle. At indentations 50, the cross-sectional area of example shaped product 32 has local minima, such that at each indentation 50 the cross-sectional area is less than the cross-sectional area at the immediately surrounding areas of example shaped product 32. Variable opening die 24 is programmed, for example, with a continuous, repeating function that would create the smooth variations in cross-sectional shape and multiple indentations 50 as depicted in FIG. 3b.

In each of the preceding, the outer material 26 and filling material 28 can comprise food formulations containing starch, sugar, protein, protein concentrates, protein isolates, vitamins, minerals, flours, fats, oils, fibers, colors, flavors, and various additives—such as processing aids, release agents, stabilizers, or functional ingredients—and other ingredients.

The invention also provides methods for making a food product, having the steps of: supplying a material capable of being functionally changed (including but not limited to by cooking); affecting a functional change on the material; motivating the functionally-changed material through a variable opening die, accompanied by changing the aperture shape or area or both of the die to produce a functionally-changed food product having a desired shape, comprising at least one variable cross-sectional dimension.

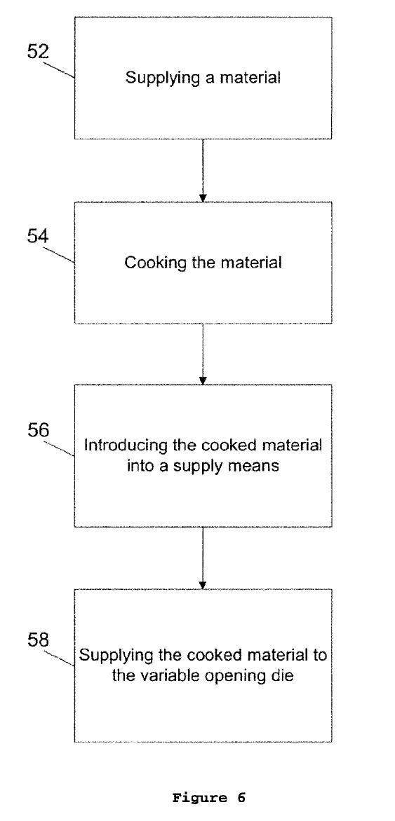

FIG. 6 is a flow diagram of an exemplary method for producing a shaped product. The steps shown in FIG. 6 could be combined or changed, and steps could be added, and the steps could be executed in any order, without departing from the true scope and spirit of the invention. At step 52, a material is supplied, and at step 54, that material functionally changed. At step 56, the now at least partially functionally changed material is introduced to a supply element capable of continuously supplying the functionally changed material to a variable opening die. At step 58, the functionally changed material is supplied to the variable opening die. Functionally changing the material can comprise subjecting the material to a change in temperature or pressure to at least partially cook the material.

In certain embodiments, the functionally changed material comprises a plurality of layers wherein at least one layer comprises a cooked material. Specific embodiments include those wherein the functionally changed material comprises an outer surrounding material and an inner filling material, wherein the outer surrounding material is a cooked material.

The fact that the final food product utilizing the various aspects of the present invention retains a predetermined shape minimizes waste by eliminating any secondary shaping. In addition, the various aspects of the invention have the additional advantage that the food product produced can be varied or changed continuously in either composition or shape, that is without having to stop production or reconfigure the apparatus by changing one shaping die for another. This advantage will be appreciated in embodiments wherein the shape or cross-sectional dimension of the final food product is changed using a particular recipe, or wherein the recipe is changed so that a different food product is motivated through the inventive apparatus, having the same or a different shape or cross-sectional dimension.

The claimed apparatus and methods advantageously permit production of a final food product having a varied shape or cross-sectional dimension, wherein the variations are predetermined in extent or configuration and can be adapted to a greater variety of shapes.

Also, the apparatus of the invention are advantageously easier to clean than apparatus known in the art, because waste production is either minimized or eliminated while shaping the material. Because the shaped product is in its final, desired form once it exits the variable opening die, no additional shaping, such as with a stamp, is required, and hence no excess material is cut off, which would result in waste. In addition, current machinery has many individual parts that must be disassembled and cleaned. The present invention, in contrast, could be cleaned by pumping water or cleaning material therethrough, or alternatively, heating the material inside to 300° C., essentially burning it, and subsequently flushing it out.

The following Examples of specific recipes and embodiments of the invention are illustrative of the present invention. These Examples are illustrative of specific embodiments of the invention, and various uses thereof. They are set forth for explanatory purposes only, and are not to be taken as limiting the invention.

### EXAMPLES

### Example 1

The recipe described in Table 1 is used to produce a snack, specifically a human or animal snack product. The ingredients in appropriate proportions are mixed together in their respective batches and are pre-conditioned before being placed in two reservoirs. The pre-conditioning ensures that the ingredients are evenly dispersed throughout the batches.

TABLE 1
Recipe.

| Ingredients | Amount (in parts) |
|---|---|
| Rice Flour | 35 |
| Glycerine | 15 |
| Fiber | 3 |
| Flavour | 0.1 |
| Water | 8 |
| Wheat Starch Pregelled | 20 |
| Gelatine | 5 |
| Gum Arabic | 5 |
| Calcium Carbonate | 4 |
| Sodium | 2.2 |
| TripolyPhosphate | |
| Potassium Chloride | 1 |
| Sodium Chloride | 1 |
| Choline Chloride | 0.5 |
| Potassium Sorbate | 0.2 |

From the reservoirs, the batches are continuously fed into extruders, and this continuous feed maintains a steady state of extruder operation. As the mixed material is metered into the extruders from each reservoir, liquid may be added to maintain viscosity. The mixed material is conveyed through the length of the extruders. In this embodiment, the extruders are screw extruders. Different sections or barrels of the extruders may engage in different processing functions with respect to the mixed material inside. The initial section of each extruder is designed to convey the mixed material away from the inlet to the extruders. The middle section of each extruder retains and mixes the mixed material at an elevated temperature. The temperature causes the starch granules in the recipe to begin hydration and gelatinization. The resulting mixed material is prepared for cooling and compression in the final section of each extruder. Controlling the temperature of the mixed material controls expansion of the mixed material. Gelatinization and protein denaturation continue in the extruders, and the mixed material enters a melt phase, in which it is compressed and sheared. Functional changes of the mixed material may be measured by various testing methods, including gelatinization percent, and evaluating the protein for denaturation.

Mixed material exits the extruders as extrudates, and the extrudates from both extruders are combined to make one uniform product as they enter the co-extrusion head. To ensure that extrudate enters the co-extrusion head at a proper rate, the rate of one extruder may be matched to another extruder. The co-extrusion head can wrap one extrudate around the other evenly, allowing the ratio of volume, diameter or both to be manually adjusted to provide an even pressure distribution at the exit of the co-extrusion head.

The combined material then exits the co-extrusion head and enters the variable opening die. The opening of the variable opening die is controlled to allow a variable cross section. After the combined material exits the variable opening die, a knife may cut the combined material into products of the appropriate length. Optionally, after cutting, the pieces may fall into a powder material such as corn starch or sugar to prevent their sticking together. The products may be cooled before packaging.

Although the invention has been described in detail with particular reference to a preferred embodiment, other embodiments can achieve the same results. Variations and modifications of the present invention will be obvious to those skilled in the art and it is intended to cover in the appended claims all such modifications and equivalents.

What is claimed:

1. An apparatus for forming a shaped body comprising:
a) one or a plurality of supply elements for continuously supplying one or more materials as a single product stream, wherein at least one supply element is adapted to supply a functionally changed material to the single product stream; and
b) a variable opening die comprising
a supporting member,
a plurality of shaping or cutter members, and
a plurality of attachments for attaching the plurality of shaping or cutter members to the supporting member,
wherein extents of the plurality of shaping or cutter members define an aperture having a shape and an area; and
the plurality of attachments are adapted to allow the plurality of shaping or cutter members to move to change the shape and the area of the aperture.

2. The apparatus according to claim 1, further comprising one or a plurality of transition tubes, each having an internal cross-sectional area and an internal cross-sectional shape, and each independently adapted for providing each material from the one or a plurality of supply elements to the variable opening die, wherein each transition tube independently has a length of about 0.25 to 10 feet.

3. The apparatus of claim 2, comprising
a) a first extruder for continuously supplying a first material and a second extruder for continuously supplying a second material, wherein at least one extruder is capable of producing a functionally changed material; and
b) a co-extrusion head in communication with the first and second extruder via a first and a second transition tube, respectively, and adapted to produce a single product stream comprising the first material surrounded by the second material.

4. The apparatus of claim 2, comprising
a single extruder capable of producing a functionally changed material for continuously supplying a first material; and
a transition tube, having an internal cross-sectional area and an internal cross-sectional shape, adapted for providing the first material from the single extruder to the variable opening die, wherein the transition tube has a length of about 0.25 to 10 feet.

5. The apparatus according to any one of claim 1, further comprising a co-extrusion head in communication with at least two supply elements and at least two transition tubes and adapted to provide a first material supplied by a first supply element and a second material supplied by a second supply element to the variable opening die as a single product stream comprising the first material surrounded by the second material.

6. The apparatus according to claim 5, further comprising a die plate or nozzle situated to provide a cross-sectional shape to the first material.

7. The apparatus according to claim 1, wherein the first supply element is an extruder.

8. The apparatus according to claim 1, wherein at least one supply element is an extruder.

9. The apparatus according to claim 1, wherein one supply element is a pump.

10. The apparatus according to claim 1, further comprising a temperature controller for controlling the temperature of the functionally changed material in the apparatus.

11. The apparatus according to claim 1, further comprising an inner ring positioned to accept a shaped body from the aperture of the variable opening die and adapted to cut the shaped body into pieces.

12. The apparatus according to claim 1, further comprising a controller for controlling the variable opening die.

13. The apparatus according to claim 12, wherein the controller varies the aperture area of the variable opening die according to a programmed, repeating, or continuous function.

14. The apparatus according to claim 1, wherein the functionally changed material is a cooked material.

15. The apparatus according to claim 1, wherein the attachments are adapted to allow the plurality of shaping or cutting members to rotate.

16. The apparatus according to claim 1, wherein at least one transition tube comprises a plurality of second members along the length of the transition tube where the second members allow for changing the internal cross-sectional area or the internal cross-sectional shape of the transition tube at one or more positions along the length of the transition tube.

17. The apparatus of claim 16, wherein the second members comprise pins.

18. The apparatus of claim 16, wherein the transition tube comprises a stack comprising a plurality of sets of pins.

19. A method for making a shaped food product comprising:
providing a single product stream comprising a plurality of materials, wherein at least one of the materials is a functionally changed material, to a variable opening die; and
varying the aperture area or shape or both of the variable opening die while the single product stream passes through the aperture to form a shaped product having a predetermined cross-sectional area and a predetermined cross-sectional shape, wherein at least one of the cross-sectional area and cross-sectional shape of the shaped product is varying.

20. The method according to claim 19, wherein the variable opening die comprises
a supporting member,
a plurality of shaping or cutter members, and
a plurality of attachments for attaching the plurality of shaping or cutter members to the supporting member, wherein extents of the plurality of shaping or cutter members define an aperture having a shape and an area; and the plurality of attachments are adapted to allow the plurality of shaping or cutter members to move to change the shape and the area of the aperture; and
a transition tube for adapted for providing the single product stream from the one or a plurality of supply elements to the variable opening die.

21. The method according to claim 19, further comprising controlling the variable opening die according to a programmed, repeating, or continuous function.

22. The method according to claim 19, wherein the cross-sectional area of the aperture is varied and the shape is essentially constant.

23. The method according to claim 19, wherein the cross-sectional area of the aperture is essentially constant and the cross-sectional shape is essentially constant.

24. The method according to claim 19, wherein at least one of the plurality of materials is a cooked material.

25. The method according to claim 19, wherein the single product stream comprises a first material and a second material, wherein the first material is surrounded by the second material.

26. The method according to claim 19, wherein the second material is a cooked material.

27. The method according to claim 19, wherein the single product stream is provided by supplying one or more materials to one or a plurality of supply elements for continuously supplying the one or more materials as the single product stream, wherein at least one supply element supplies a functionally changed material to the single product stream.

28. The method according to claim 27, wherein at least one supply element is an extruder.

29. The method according to claim 27, wherein at least one supply element is a pump.

30. The method according to claim 27, further comprising functionally changing at least one of the materials to form one or more functionally changed materials in the supply element.

31. The method according to claim 30, wherein the functional change is cooking.

32. A method for producing a plurality of final formed food products using an apparatus according to claim 1, wherein the plurality of final formed food products differ by having a final formed shape or recipe or both shape and recipe, wherein the different shapes of the two formed food products are produced by different aperture shape, area, or both shape and area of the variable opening die used to produce each of the two final formed food products, or the recipe of each of the two final formed food products is different and the two final formed food products are produced sequentially in the apparatus.
